(19) United States
(12) Patent Application Publication
(10) Pub. No.: US 2015/0048057 A1
(43) Pub. Date: Feb. 19, 2015

(54) SEMI-AUTOMATIC WELDING SYSTEM, CONVERSION ADAPTER KIT, AND WELDING TORCH

(71) Applicant: TAIYO NIPPON SANSO CORPORATION, Tokyo (JP)

(72) Inventor: Katsunori Wada, Tokyo (JP)

(21) Appl. No.: 14/388,046

(22) PCT Filed: Nov. 20, 2012
(86) PCT No.: PCT/JP2012/080108

§ 371 Date: Sep. 25, 2014

(30) Foreign Application Priority Data
Mar. 29, 2012 (JP) 2012-077309

(51) Int. Cl. B23K 9/29; B23K 9/167; B23K 9/26

(52) U.S. Cl. CPC B23K 9/296; B23K 9/26; B23K 9/167
USPC 219/75

(57) ABSTRACT

According to the present invention, a non-consumable electrode type semi-automatic welding system which can conduct welding with high weld deposit and high speed is provided. A welding torch (1), in which a non-consumable electrode (1) generating an arc between the non-consumable electrode and an object to be welded and a torch nozzle (5) ejecting a shield gas toward a welding pool of the object to be welded generated by the arc are provided; a wire feeder (502) which delivers a welding wire (10) toward the welding pool of the object to be welded from a tip end of a feeding head, the feeding head being mounted on the welding torch (1) via an attaching jig (14); and a welding power source (501) which supplies electric power and shield gas to the welding torch (1); are provided and one or more among the welding torch (1), the wire feeder (502), and the welding power source (501) are constituted by applying at least one part of a welding torch, wire feeder, and welding power source provided in a consumable electrode type semi-automatic welding system.

### TECHNICAL FIELD

The present invention relates to a semi-automatic welding system, conversion adapter kit, and welding torch. The present application claims priority on the basis of Japanese Patent Application No. 2012-077309, filed in Japan on Mar. 29, 2012, the contents of which are incorporated herein by reference.

### BACKGROUND ART

In welding of a structure (object to be welded) using metal or non-ferrous metal as a base material, a non-consumable-type gas-shielded arc welding called TIG welding (Tungsten Inert Gas welding) or GTAW welding (Gas Tungsten Arc welding) such as plasma arc welding has been conventionally used.

Also, a consumable-type gas-shielded arc welding called MIG welding (Metal Inert Gas welding), MAG welding (Metal Active Gas welding), or GMAW (Gas Metal Arc welding) such as carbon dioxide arc welding has been used. The consumable-type gas-shielded arc welding, in which welding is manually conducted while a welding wire to become a consumable electrode is automatically supplied, is also called semi-automatic arc welding.

In these welding methods, it is general that an arc is generated between the electrode and object to be welded using a welding torch and welding is conducted while forming a welding pool (pool) by melting the welding object due to the arc heat. Also, during welding, a shield gas is ejected from a torch nozzle surrounding the electrode and welding is conducted while blocking the atmosphere (air) by the shield gas.

As shown in FIGS. 13A and 13B, a general TIG welding torch 100 which is traditionally used will be explained. FIG. 13A is a lateral view of the TIG welding torch 100 and FIG. 13B is a cross-sectional view showing the main section of the TIG welding torch 100.

In this TIG welding torch 100, as shown in FIGS. 13A and 13B, a non-consumable electrode 101 which generates an arc between the non-consumable electrode 101 and an object to be welded, a collet 102 which supports the non-consumable electrode 101 in a state where the non-consumable electrode 101 is inserted on the inside of the collet 102, a collet body 103 on the inside of which the collet 102 is held in a state of projecting the non-consumable electrode 101 from the tip side, a torch body 104 on which the collet body 103 is mounted, a torch nozzle 105 which is mounted on the collet body 103 in a state of surrounding the non-consumable electrode 101 and ejects a shield gas, a front gasket 106 which is disposed between the torch body 104 and the torch nozzle 105, a torch cap 108 which is mounted in a state of disposing a rear gasket 107 between the torch body 104 and the torch cap 108, and a handle 109 on which the torch body 104 is mounted and which a user grips are provided in outline.

Also, in this TIG welding torch 100, after connecting a welding cable C, welding is conducted by generating an arc between the non-consumable electrode 101 and the object to be welded while a shield gas is ejected from the torch nozzle 105.

On the other hand, as shown in FIG. 14, a general MIG (or MAG) welding torch 200, which has been conventionally used, will be explained. FIG. 14 is a lateral view showing one example of the MIG (or MAG) welding torch 200. FIG. 14 shows the welding torch 200, one part of which is cut and not shown.

In the MIG (or MAG) welding torch 200, as shown in FIG. 14, a consumable electrode 201 which generates an arc between the consumable electrode 201 and an object to be welded, a contact tip 202 which guides the consumable electrode 201 and from the tip side of which the consumable electrode 201 is delivered, a torch body 203 on which the contact tip 202 is mounted, a torch nozzle 204 which is mounted on the torch body 203 in the state of surrounding the contact tip 202 and ejects a shield gas, and a handle 205 on which the torch body 203 is mounted and which a user grips are provided in outline.

Also, in this MIG (or MAG) welding torch 200, after connecting a welding cable C, welding is conducted by generating an arc between the consumable electrode 201 and the object to be welded while a shield gas is ejected from the torch nozzle 204. Moreover, in the MIG (or MAG) welding torch 200, because welding is conducted while the consumable electrode 200 itself is melted in the arc, a mechanism in which the consumable electrode 201 is automatically supplied through the inside of the handle 205 is included.

However, because TIG welding is conducted on a comparatively thin sheet, the welding is conducted within the range of 50-200 A in terms of the used current. Therefore, when welding is conducted on a thick object to be welded, because an amount of weld deposit is lacking, it is necessary to conduct welding through multiple passes.

For example, when horizontal fillet welding in which high strength is required is conducted using the TIG welding, because a melted amount is lacking, a leg length and throat are needed in order to obtain joint performance. In this case, by supplying a filler metal, the leg length and throat are ensured.

Also, when TIG welding is manually conducted, although a method in which a welding wire is used as the filler metal and in a process of which the welding wire is automatically supplied is applied, in almost all processes, it is manually supplied.

As a device for automatically supplying a welding wire, there is an automatic instrument such as a robot for TIG welding. Then, a TIG welding apparatus in which TIG welding is conducted while the welding wire is automatically supplied by mounting such a device on a welding torch for TIG welding (for example, see Patent Documents 1 to 4) is suggested.

On the other hand, in a case where it is necessary to conduct welding at higher speed and with a larger amount of weld deposit than when TIG welding is conducted, consumable electrode-type gas shield arc welding such as MAG welding is used. In MAG welding, by mixing inert gas and carbon dioxide with shield gas and using it, it is possible to deepen penetration at a welded part.

Because MAG welding is conducted within the range of 100-500 A in terms of used current, it is suitable for a thick sheet. In MAG welding, by using a MAG welding torch in which a welding wire to be a consumable electrode is delivered from the tip side of the contact tip, the welding wire is automatically supplied to conduct welding while the wire itself is melted in the arc.

In this way, non-consumable electrode type gas shield arc welding (for example, TIG welding) and consumable electrode type shield arc welding (for example, MIG welding or MAG welding) are categorized according to an object to be welded or thickness of sheet. Therefore, it has been necessary to prepare several welding apparatus in conformity with target objects to be welded.

### CITATION LIST

### Patent Literature

Patent Document 1: Japanese Unexamined Patent Application, First Publication No.
Patent Document 2: Japanese Unexamined Patent Application, First Publication No. 2001-138053
Patent Document 3: Japanese Unexamined Patent Application, First Publication No. 2007-000933
Patent Document 4: Japanese Unexamined Patent Application Publication (Translation of PCT Application) No. 2009-545449

### SUMMARY OF INVENTION

### Problem to be Solved by the Invention

However, in the TIG welding, when, in order to increase an amount of welded deposit, welding is attempted using the general TIG welding torch while a filler metal (filler rod) is manually supplied while flowing high current, there was a case in that a supply of the filler metal is too late. In this case, because a user needs to conduct both supply of filler metal and control of the TIG welding torch 100 with right and left hands at the same time, a skilled technique is needed.

Also, when TIG welding is conducted while flowing high current, because the handle 109 of the welding torch 100 is near the arc, there is a possibility that hands are burned. Moreover, the possibility that the torch nozzle 105 is damaged by heat becomes high.

On the other hand, because a welding wire is supplied automatically, when a guide for wire positioning is mounted on the general TIG welding torch 100 and TIG welding is conducted semi-automatically, the circumference of the torch on which the guide for wire positioning is mounted becomes large, thus extremely deteriorating usability.

Also, when high current flows in semi-automatic TIG welding, there is a possibility that hands are burned due to controlling a welding torch manually. Moreover, there is the threat that the resin part of the guide for wire positioning is melted since it cannot withstand welding with high current.

In contrast, the MAG welding can conduct welding at high current having a high amount of weld deposition. However, in the MAG welding, slag, metal particles, and the like (called sputter) fly about easily during welding and a post-treatment is needed after welding. Also, there are problems in that the end result of a welded part is not as aesthetically pleasing as one obtained by TIG welding and welding defects are generated easily.

Moreover, when using mixed gas (MAG welding), in which oxygen or carbon dioxide is mixed with a shield gas, or 100% carbon dioxide (carbon dioxide arc welding), materials in which welding defects such as holes are generated cannot be used.

In consideration of these circumstances surrounding the prior art, the present invention is proposed and intended to provide a non-consumable electrode type semi-automatic welding system which can conduct welding at high speed having a high weld deposit, a conversion adapter kit which switches a consumable electrode type welding torch to a non-consumable electrode type welding torch, and a welding torch on which the conversion adapter kit is mounted.

### Means for Solving the Problem

In order to achieve the object, the present invention provides the following.

(1) A non-consumable electrode type semi-automatic welding system, comprising:

a welding torch in which a non-consumable electrode generating an arc between an object to be welded and the non-consumable electrode and a torch nozzle ejecting a shield gas toward a welding pool of the object to be welded generated by the arc are provided;

a wire feeder which delivers a welding wire toward the welding pool of the object to be welded from a tip end of a feeding head mounted on the welding torch via an attaching jig; and

a welding power source which supplies electric power and the shield gas to the welding torch; wherein one or more among the welding torch, the wire feeder, and the welding power source applies at least one part among a welding torch, a wire feeder, and a welding power source provided in a consumable electrode type semi-automatic welding system.

(2) A non-consumable electrode type semi-automatic welding system according to (1), wherein the welding torch applies at least one of parts of a consumable electrode type welding torch in which a contact tip delivering a consumable electrode from a tip end; a torch body on which the contact tip is mounted; a torch nozzle which is mounted on the torch body and ejects a shield gas; and a handle on which the torch body is mounted and which a user grips are provided.
(3) A non-consumable electrode type semi-automatic welding system according to (2), wherein the welding torch applies at least the torch body, torch nozzle, and handle provided in the consumable electrode type welding torch by providing a conversion contact tip which instead of the contact tip is mounted on the torch body and a fixing jig with which the non-consumable electrode is mounted on the conversion contact tip.
(4) A non-consumable electrode type semi-automatic welding system according to (2), wherein the welding torch applies at least the torch body, torch nozzle, and handle provided in the consumable electrode type welding torch by providing a collet which supports the non-consumable electrode in a state of inserting the non-consumable electrode on the inside and a conversion collet body which holds the collet inside in a state of ejecting the non-consumable electrode from a tip side and which instead of the contact tip is mounted on the torch body.
(5) A non-consumable electrode type semi-automatic welding system according to (2), wherein the welding torch applies at least the handle provided in the consumable electrode type welding torch by providing a collet which supports the non-consumable electrode in a state of inserting the non-consumable electrode on the inside; a collet body which holds the collet inside in a state of ejecting the non-consumable electrode from a tip side; the torch nozzle which is mounted on the collet body and ejects the shield gas; and a conversion torch body on which the collet body is mounted and which, instead of the torch body, is mounted on the handle.
(6) A non-consumable electrode type semi-automatic welding system according to any one of (1) to (5), wherein the feeding head applies a contact tip provided in the consumable electrode type welding torch.
(7) A non-consumable electrode type semi-automatic welding system according to any one of (1) to (6), wherein, in the feeding head, a delivering position of the welding wire can be adjusted by changing a position of the attaching jig.
(8) A non-consumable electrode type semi-automatic welding system according to any one of (1) to (7), wherein the welding power source applies at least one part of the electric source device provided in the consumable electrode type semi-automatic welding system.
(9) A non-consumable electrode type semi-automatic welding system according to (8), wherein the maximum of a rated output current in the welding power source is 200 A or more.
(10) A non-consumable electrode type semi-automatic welding system according to any one of (1) to (9), wherein the wire feeder applies at least one part of a wire feeder provided in the consumable electrode type or the non-consumable electrode type semi-automatic welding system.
(11) A non-consumable electrode type semi-automatic welding system according to any one of (1) to (10), wherein a cooling device which cools the welding torch by connecting to the welding power source and recycling cooling liquid flowing in the welding torch is provided.
(12) A conversion adapter kit, with which a consumable electrode type welding torch including:

a contact tip which delivers a consumable electrode from a tip end;

a torch body on which the contact tip is mounted

a torch nozzle which is mounted on the torch body and ejects a shield gas

a handle on which the torch body is mounted and which a user grips, is converted to a non-consumable electrode type welding torch including

a non-electrode which generates an arc between the non-consumable electrode and object to be welded, comprising:

a conversion contact tip which instead of the contact tip is mounted on the torch body; and

a fixing jig with which the non-consumable electrode is mounted on the conversion contact tip.

(13) A conversion adapter kit, with which a consumable electrode type welding torch including:

a contact tip which delivers a consumable electrode from a tip end;

a torch body on which the contact tip is mounted

a torch nozzle which is mounted on the torch body and ejects a shield gas

a handle on which the torch body is mounted and which a user grips, is converted to a non-consumable electrode type welding torch including

a non-electrode which generates an arc between the non-consumable electrode and object to be welded, comprising:

a collet which supports the non-consumable electrode in a state of inserting the non-consumable electrode on the inside; and

a conversion collet body which holds the collet inside in a state of ejecting the non-consumable electrode from a tip side and which instead of the contact tip is mounted on the torch body.

(14) A conversion adapter kit, with which a consumable electrode type welding torch including:

a contact tip which delivers a consumable electrode from a tip end;

a torch body on which the contact tip is mounted

a torch nozzle which is mounted on the torch body and ejects a shield gas

a handle on which the torch body is mounted and which a user grips, is converted to a non-consumable electrode type welding torch including

a non-electrode which generates an arc between the non-consumable electrode and object to be welded, comprising:

a collet which supports the non-consumable electrode in a state of inserting the non-consumable electrode on the inside;

a collet body which holds the collet inside in a state of ejecting the non-consumable electrode from a tip side; and

a conversion torch body on which the collet body is mounted and which instead of the torch body is mounted on the handle.

(15) A conversion adapter kit according to any one of (12) to (14), further comprising: a non-consumable electrode.
(16) A conversion adapter kit according to any one of (12) to (15), further comprising:

a feeding head which delivers a welding wire from a tip end; and

an attaching jig with which the feeding head is mounted on the welding torch.

(17) A conversion adapter kit according to (16), wherein the feeding head applies the contact tip provided in the consumable electrode type welding torch.
(18) A conversion adapter kit according to (16) or (17), wherein, in the feeding head, a delivering position of the welding wire can be adjusted by changing a position of the attaching jig.
(19) A welding torch, on which a conversion adapter kit according to any one of (11) to
(18) is mounted.

### Effect of the Invention

As described above, according to the present invention, a non-consumable electrode type semi-automatic welding system to which at least one part of a consumable electrode type semi-automatic welding system is applied and which can conduct a welding at a high speed having a high weld deposit, a conversion adapter kit, which switches a consumable electrode type welding torch to a non-consumable electrode type welding torch, in such a semi-automatic welding system, and a welding torch on which the conversion adapter kit is mounted can be provided.

### BRIEF DESCRIPTION OF DRAWINGS

FIG. 1A is a side view showing one example of a welding torch and conversion adapter kit according to the present invention.

FIG. 1B is a sectional view enlarging a main part of the welding torch shown in FIG. 1A.

FIG. 2 is a schematic view viewed from a side in direction of welding line in the state of welding using the welding torch shown in FIG. 1A.

FIG. 3A is a schematic view in a case where the welding pool of object to be welded becomes concave shape during welding.

FIG. 3B is a schematic view in a case where the welding pool of object to be welded becomes convex shape during welding.

FIG. 4A is a side view showing an attaching structure using another fixing jig.

FIG. 4B is a side view showing an attaching structure using another fixing jig.

FIG. 4C is a side view showing an attaching structure using another fixing jig.

FIG. 5 is a side view showing another conversion adapter kit.

FIG. 6A is a side view showing another conversion adapter kit.

FIG. 6B is a side view showing the state where the conversion adapter kit shown in FIG. 6A is attached on a handle.

FIG. 7A is a side view showing another guide for wire positioning.

FIG. 7B is a side view showing another guide for wire positioning.

FIG. 8 is a side view showing a guide for wire positioning on which a damper mechanism is provided.

FIG. 9 is a schematic view showing one structure example of a semi-automatic welding system according to the present invention.

FIG. 10 shows photographs of the appearance after conducting a butt welding in Example 1.

FIG. 11 shows photographs of the appearance after conducting a horizontal fillet welding in Example 2.

FIG. 12 is a photograph showing a cross-sectional surface after conducting a horizontal fillet welding in Example 3.

FIG. 13A is a side view showing one example of a conventional TIG welding torch.

FIG. 13B is a sectional view showing a main part of a TIG welding torch shown in FIG. 13A.

FIG. 14 is a side view showing one example of a conventional MIG (or MAG) welding torch.

### DESCRIPTION OF EMBODIMENTS

The following provides an explanation of a semi-automatic welding system, conversion adapter kit, and welding torch according to to the present invention with reference to the drawing.

### (Welding Torch and Conversion Adapter Kit)

At first, one example of a welding torch and conversion adapter kit will be explained.

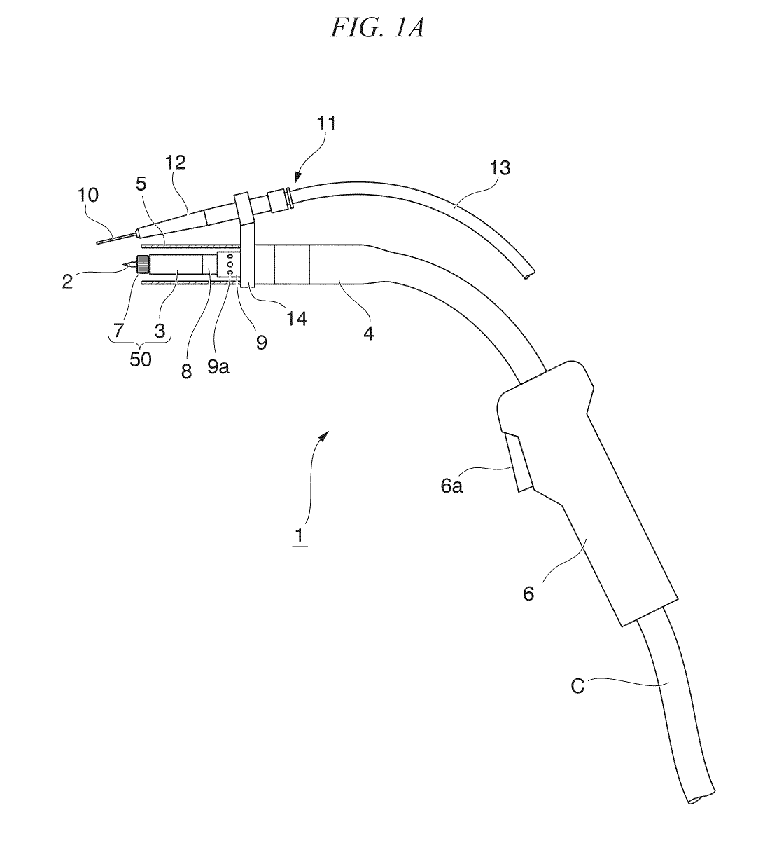

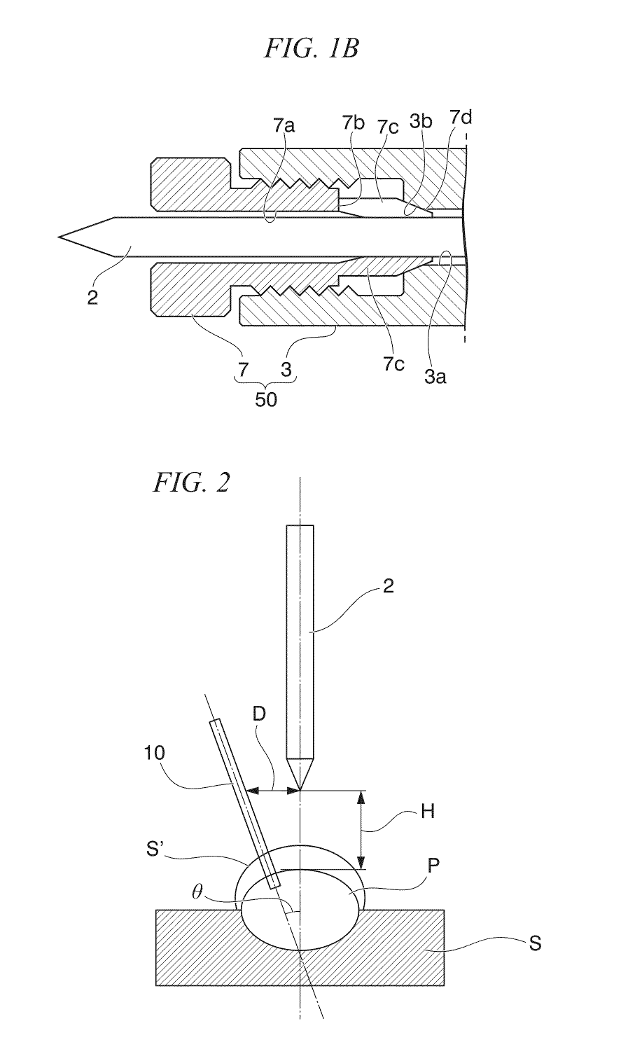

FIG. 1A is a side view showing one example of a welding torch 1 according to the present invention. FIG. 1A shows the welding torch 1 a part of which is cut and not shown. FIG. 1B is a sectional view enlarging a main part of the welding torch 1 shown in FIG. 1A.

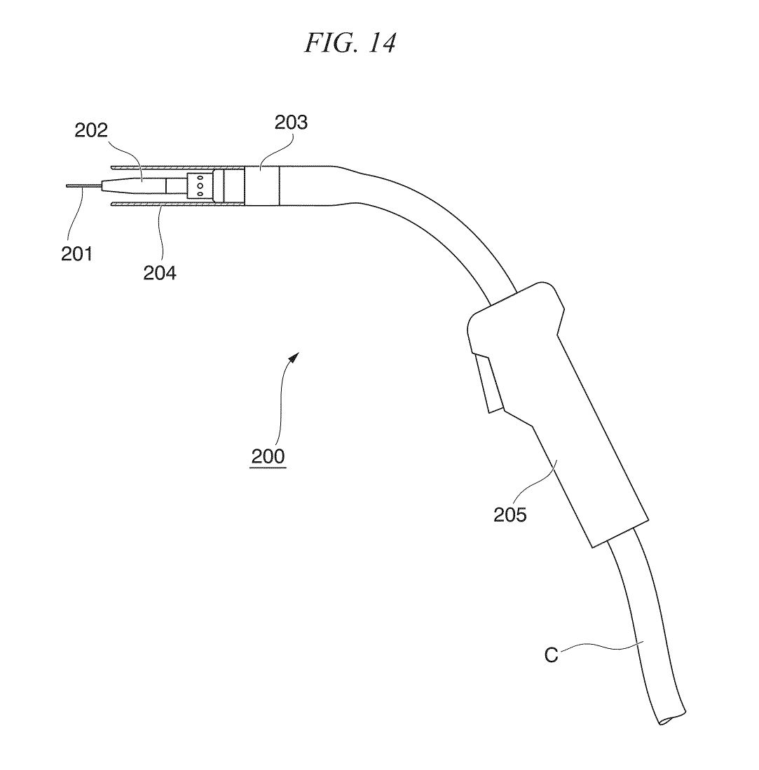

To the welding torch 1, at least one part of MIG (or MAG) welding torch 200 (consumable electrode type welding torch), for example, as shown in FIG. 14, is applied. In particular, using a conversion adapter kit 50 according to the present invention, it includes a structure, on which the non-consumable electrode 2 is mounted instead of a consumable electrode 201 used for the MIG (or MAG) welding torch 200. Also, the welding torch 1 can conduct a welding manually while supplying a welding wire 10 as a filler metal automatically.

In particular, in the welding torch 1 as shown in FIG. 1A and FIG. 1B, a non-consumable electrode 2 which can generate an arc between the non-consumable electrode 2 and an object to be welded, a contact tip 3 on which the non-consumable electrode 2 is mounted, a torch body 4 on which the contact tip 3 is mounted, a torch nozzle 5 which is mounted on the torch body 4 in a state of surrounding the contact tip 3 and ejects a shield gas, and a handle 6 on which the torch body 4 is mounted and which a user grips are provided in outline.

The non-consumable electrode 2 comprises a long electrode bar formed using a metallic material of high melting point, for example, tungsten.

The contact tip 3 comprises a roughly cylindrical member formed using metallic material of excellent electric conductivity and heat conductivity, for example, copper or copper alloy. Also, the contact tip 3 has a through-hole 3a passing through in the axis direction, the consumable electrode can be generally passed through the through-hole 3a and is delivered to the tip side.

In contrast, in a welding torch 1 according to the present invention, the non-consumable electrode 2 is mounted on the contact tip 3 via a fixing jig in a state where the non-consumable electrode 2 is inserted to the through-hole 3a of the contact tip 3. That is, the contact tip 3 is a conversion contact tip which instead of a contact tip 202 used for MIG (or MAG) welding torch 200 shown in FIG. 14 is mounted on the torch body 4,.

In the conversion adapter kit 50 according to the present invention, the conversion contact tip 3 and the fixing jig 7 are provided and constructed. In the welding torch 1 according to the present invention, by using the conversion adapter kit 50, MIG (or MAG) welding torch 200 shown in FIG. 14 can be converted to TIG welding torch. Therefore, for the torch body 4, torch nozzle 5, and handle 6 mounted on the welding torch 1, a torch body 203, torch nozzle 204, and handle 205 provided in MIG (or MAG) welding torch 200 shown in FIG. 14 can be applied.

The fixing jig 7 comprises a roughly cylindrical member formed using metallic material of excellent electric conductivity and heat conductivity, for example, copper or copper alloy. The fixing jig 7 has a through-hole 7a passing through in the axis direction and support the non-consumable electrode 2 which is inserted on the inside of the through-hole 7a as it can slide in the axis direction Also, in the base end of the fixing jig 7, multiple slits 7b are provided side by side in a circumferential direction. These multiple slits 7b provided from the base end of the fixing jig 7 is linearly-cutout midway in the axis direction. For this, a chock section 7c in which an elastic deformation can be changed in the shrunk radial direction are formed between each of slits 7b. Also, in the tip side of the chock section 7c, a taper section 7d, the radius of which is shrunk by little and little, is provided.

Then, this fixing jig 7 can be threadably mounted on the inner circumference side of the contact tip 3 removably, in a state where the end side is inserted on the inside of the contact tip 3. Also, when the fixing jig 7 is mounted on the contact tip 3, in the inside of this contact tip 3, the taper section 7d of the fixing jig 7 is directly contacted with a taper surface 3b provided on the inside of the contact tip 3 and thereby the elastic deformation in the chock section 7c of this fixing jig 7 is changed in the shrunk radial direction. For this, the non-consumable electrode 2 can be fixed to the contact tip 3 while the non-consumable electrode 2 is sandwiched between the chock sections 7c of the fixing jig 7.

Moreover, in the contact tip 3, the base end can be threadably mounted on the torch body 4 removably. In contract, in the torch body 4, a tip body 8 for mounting this contact tip 3 is integrated or is independently mounted.

The tip body 8 comprises a roughly cylindrical member formed using metallic material of electric conductivity, the heat conductivity of which is lower than one of the contact tip 3, for example, a steel such as mild steel and stainless steel, or a brass. Also, in the inside of the tip body 8, a flow channel in which a shield gas supplied from the side of the torch body 4 flows is formed.

Also, in the outer circumference section in the base end of the tip body 8, an orifice 9 is provided. At the outer circumference section of this orifice 9, multiple ejection holes 9a from which a shield gas is ejected are provided side by side in a circumferential direction.

The torch body 4 includes a roughly cylindrical metallic component body (not shown in Figs) formed using metallic material of electric conductivity, the heat conductivity of which is lower than one of the contact tip 3, for example, a steel such as mild steel and stainless steel, or a brass. The metallic component body has structure covered with insulating resin.

The metallic component body forms a power feeding portion which supplies electric power to the non-consumable electrode 2 via the contact tip 3 and tip body 8. Also, the inside forms a flow channel supplying a shield gas toward the contact tip 3. Then, the contact tip 3 can be removably threadably mounted on the tip body 8 which is mounted on one side (the tip side) of this metallic component body.

The torch nozzle 5 is for rectifying the shield gas ejected from the orifice 9 and includes a roughly cylindrically-formed nozzle structure using a metallic material or insulating material of excellent heat resistance. Then, the torch nozzle 5 can be threadably mounted on the outer circumference section of the torch body 4 removably. Because the tip side of torch nozzle 5 is exposed to high temperature, only the tip side can be constructed by using another member of excellent heat resistance.

As a shield gas, a single inert gas, for example, argon and helium or mixture of multiple inert gases can be used. Moreover, it is possible that hydrogen, nitrogen, or the like is added to the shield gas. In this case, because oxidation gas is not used, an oxidation of bead formed in the object to be welded can be reduced and wettability can be improved.

In the handle 6, a switch 6a exchanging on/off is provided. Also, in the handle 6, a connection provided on the other side (back side) of the torch body 4 is removably mounted. Then, through the inside of the handle 6, a welding cable C can be threadably connected to the connection of the torch body 4. Moreover, the handle 6 does not apply only handle type and may apply pencil type.

On the inside of the welding cable C, for example, a supplying cable, in which an external electrode supplies electric power to the metallic component body (power feeding portion) of the torch body 4, a liner (also called conduit), which supplies a shield gas or wilding wire (consumable electrode) to the metallic component body (flow channel), and the like are provided.

On the welding torch 1, a guide for wire positioning (also called guide chip body or guide ring) 11 is mounted in order to automatically supply welding wire 10 as filler metal. In the guide for wire positioning 11, a feeding head 12, from the tip side of which the welding wire 10 is delivered with guiding the welding wire 10, and a liner 13 which supply the welding wire 10 toward the tip side of the feeding head 12 are provided and a structure, in which the feeding head 12 is removably mounted on the outer circumference section of the torch nozzle 5 via the attaching jig 14, is included.

The feeding head 12 can use a general contact tip used in a consumable electrode type welding torch. In the attaching jig 14, by changing a position of front-back direction or a position around the axis in the outer circumference section of the torch nozzle 5, a supplying position of the welding wire 10 can be optionally adjusted.

Also, for the welding wire 10, it is possible to arbitrarily choose and use the most suitable welding materials among conventionally known materials according to a base material of object to be welded. Moreover, the attaching jig 14 does not apply only to a structure directly mounted on the outer circumference section of the torch nozzle 5 and may apply a structure mounted on the outer circumference section of the torch nozzle 5 via insulating member (not shown in figures).

When welding using the welding torch 1, an arc is generated between an object to be welded and non-consumable electrode 2 to form a welding pool (pool) by melting the object to be welded due to a heat of the arc. During welding, a shield gas is ejected from the torch nozzle 5 surrounding the non-consumable electrode 2 and atmosphere (air) is blocked by the shield gas. Also, during welding, the welding wire 10 is automatically supplied toward the welding pool of the object to be welded and welding is conducted with melting the welding wire 10 in the arc.

In this case, because the welding wire 10 is automatically supplied, the welding torch 1 can be controlled by both hands and the welding operation can be stably and easily conducted without a skilled technique.

As above, in the welding torch 1 according to the present invention, by using the conversion adapter kit 50, the non-consumable electrode 2 instead of the consumable electrode 201 used for the MIG (or MAG) welding torch 200 shown in the FIG. 14 is mounted on the contact tip 3 via the fixing jig 7.

For this, MIG (or MAG) welding torch 200 shown in the FIG. 14 can be converted to TIG welding torch to be used. Also, in this case, TIG welding torch needs not be newly prepared and this welding torch 1 and conversion adapter kit 50 can be provided at a low price.

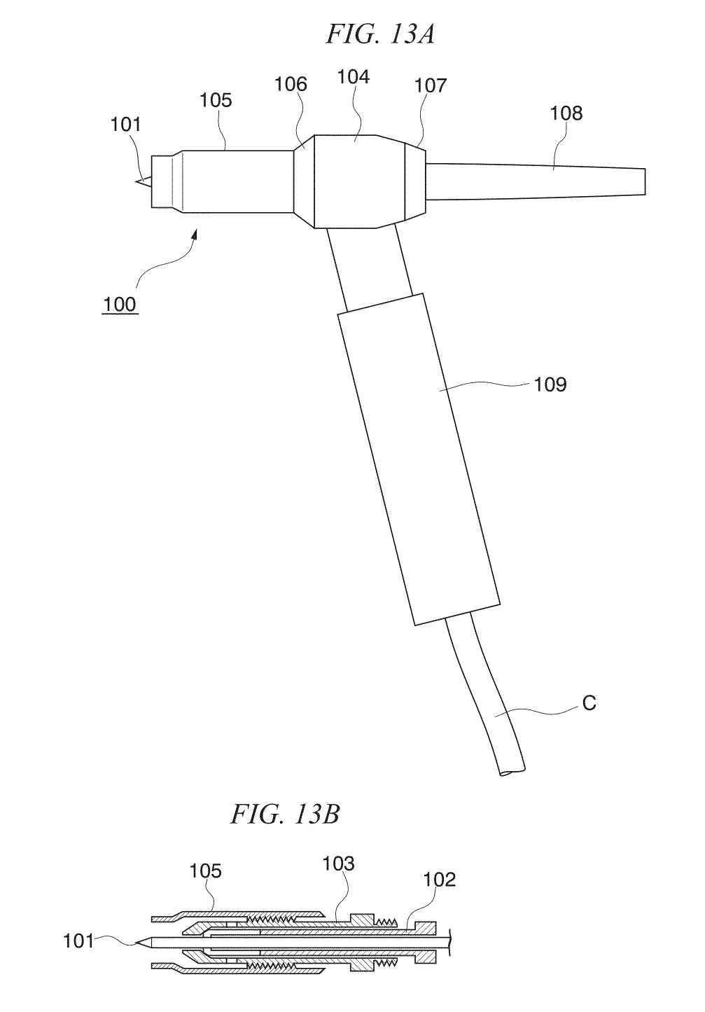

Moreover, the welding torch 1 according to the present invention can apply MIG (or MAG) welding torch 200 in which comparatively high current (for example, 200 A or more) can be flowed compared with TIG welding torch 100 shown in the FIG. 13A and FIG. 13B. In addition, the guide for wire positioning 11 is mounted on the welding torch 1 and semi-automatically TIG welding can be conducted with supplying the welding wire 10 automatically.

For this, a welding with a high speed and a high weld deposit can be conducted with preventing sputter from being generated. Also, because a user needs not conduct both supply of filler metal and control of TIG welding torch 100 with right and left hands at the same time as a conventional manually-powered TIG welding, welding to obtain a good end result can be conducted without need of a skilled technique.

Moreover, even when flowing high current in semi-automatically TIG welding, because the welding torch 1 applies MIG (or MAG) welding torch 200 accepting high current, there is possibility of preventing, the torch nozzle 5, the guide for wire positioning 11, and the like from being broken by heat as conventionally TIG welding torch.

In addition, when using mixed gas (MAG welding) in which oxygen or carbon dioxide is mixed with a shield gas, or 100% carbon dioxide (carbon dioxide arc welding), materials in which welding defects such as holes are generated can be also used.

Also, even when the welding torch 1 is manually controlled, the distance from the arc to the handle 6 is more sufficient than conventionally TIG welding torch, it is possible to prevent hands from being burned.

Moreover, even when the guide for wire positioning 11 is mounted on the welding torch 1 and semi-automatically TIG welding is conducted, because the distance from the torch nozzle 5, on which the guide for wire positioning 11 is mounted, to the handle 6 is sufficient, the guide for wire positioning 11 is not a hamper during welding.

As above, when the welding torch 1 is used, despite automatically TIG welding, welding with high speed and high weld deposit like MIG (or MAG) welding can be conducted.

The state of the welding torch 1 during welding is schematically shown in FIG. 2. FIG. 2 is a view in the state of the welding torch 1 during welding, the view being viewed from a side in direction of welding line.

As shown in FIG. 2, when welding is conducted using the welding torch 1, it is preferably that, in a state where a slope angle of the welding wire 10 to the non-consumable electrode 2 is 10-45°, the welding wire 10 is supplied toward the welding pool P of the object to be welded S. By setting the slope angle to 10-45°, a welding operation can be conducted in a similar sense of a shield metal arc welding. Also, the welding operation can be conducted on narrow place. S′ part in FIG. 2 shows extra deposit formed in the object to be welded S after welding.

Although an inside of the welding pool P cannot be observed during welding, it can be supposed that the phenomenon where a non-melting state and a melting state are repeated in the welding wire 10 occurs during welding. At this time, because a sense of resistance at a time when it is changed from the melting state to the non-melting state reaches to hands griping the handle 6 of the welding torch 1, a suitable arc length can be kept by using the sense of resistance as an indication.

Also, the sense of resistance is similar with a sense of reaching a hand at a time when a tip side of a filler rod is pushed to the object to be welded S in a shield metal arc welding, which does not need a particularly skilled technique. In particular, by setting a slope angle of the welding wire 10 to the non-consumable electrode 2 to 10-45°, the sense can be obtained. Also, when an end side of the welding wire 10 is pushed to the object to be welded S during welding, a pushing force is preferably within the range of 0.2-10N and more preferably within the range of 0.5-5N.

When the welding wire 10, not a welding rod, is used as the filler metal, a filler metal can be continuously supplied. On the other hand, because the welding wire 10 is supplied from the states of being rolled in a spool, when it is delivered from the tip side of the feeding head 12, there is a case where the welding wire 10 cannot be straight supplied due to rolling behavior. In this case, there is possibility of contacting the non-electrode 2 before supplying the welding wire 10 delivered from the tip side of the feeding head 12 to the welding pool P.

In this, as shown in FIG. 2, the distance D from the tip end of the non-consumable electrode 2 to welding wire 10 in a horizontal direction is preferably 2 mm or more and 8 mm or less. When the distance D is shorter than 2 mm, the possibility of contacting the non-consumable electrode 2 with the welding wire 10 becomes high.

On the other hand, by setting the distance D to be greater with electric current being greater, a transfer configuration of the welding wire 10 can be controlled, and then the maximum of the distance D is 8 mm. That is, when the distance D is too short, the welding wire 10 becomes droplet before reaching the welding pool P, as it is called a droplet transfer configuration. On the other hand, when the distance D is too long, the welding wire 10 reaches the welding pool P in the state of non-melting or semi-melting, as it is called a bridge transfer configuration.

The transfer configuration of the welding wire 10 like this is changed according to magnitude of electrical current. Therefore, by adjusting the distance D, a bridge transfer configuration or droplet transfer configuration can be selected according to the purpose or welding person's like. In particular, the distance D is 2 mm or more and 5 mm or less, more preferably. When the distance D is over 5 mm, it is necessary to consider a possibility of the welding wire 10 not being completely melted causing a defect such as incomplete fusion.

Also, a distance H from the tip end of non-consumable electrode 2 to the welding pool P in a vertical direction is preferably 3 mm or more 10 mm or less and more preferably 3 mm or more and 5 or less. For example, considering a variation of arc length of manually arc welding can make it difficult for the tip end of the non-consumable electrode 2 to contact the welding pool P. When the distance H is shorter than 3 mm, the possibility, in that the tip end of non-consumable electrode 2 contacts the welding pool P, becomes high. On the other hand, when the distance H is longer than 10 mm, a shield gas is lacking and the shield property becomes worse.

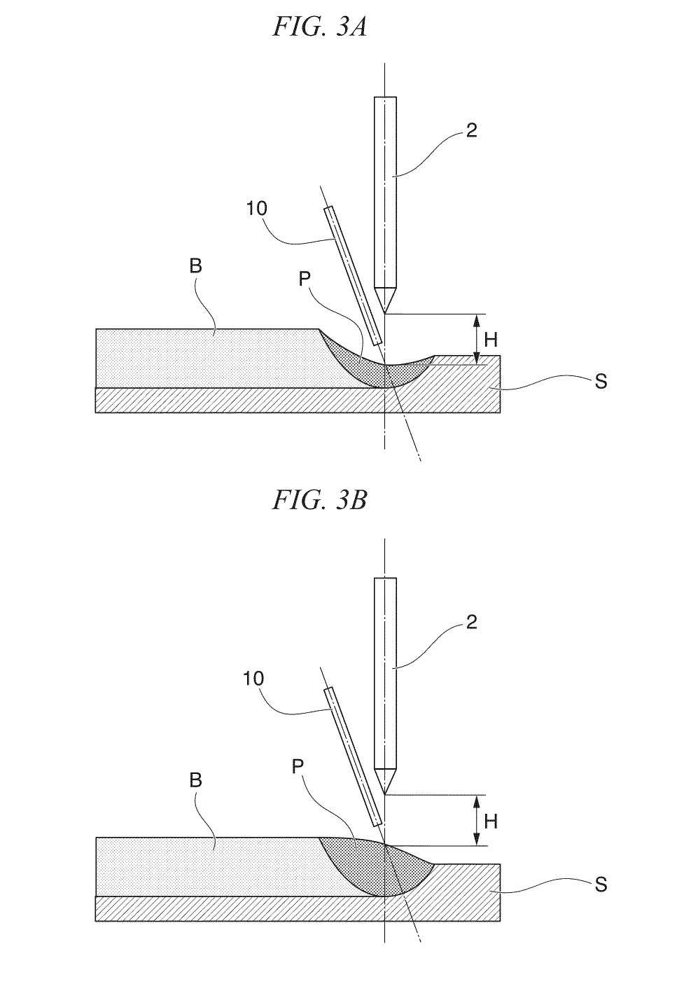

For the welding pool P of the objects to be welded S, there is a case of becoming concave form shown in FIG. 3A or a case of becoming convex form shown in FIG. 3B according to magnitude of electrical current. Therefore, the distance H is changed in the depth direction according to magnitude of electrical current. For this, although it is difficult to preliminary set the distance H before welding, if the distance H is 3 mm or more, the distance H can be controlled by eye when based on a manually welding. B part in FIG. 3A and FIG. 3B shows bead formed in the object to be welded S after welding.

The welding torch and conversion adapter kit according to the present invention are not always limited to the welding torch 1 and conversion adapter kit 50 shown in the above embodiments and a variety of modifications can be added within the scope of the invention.

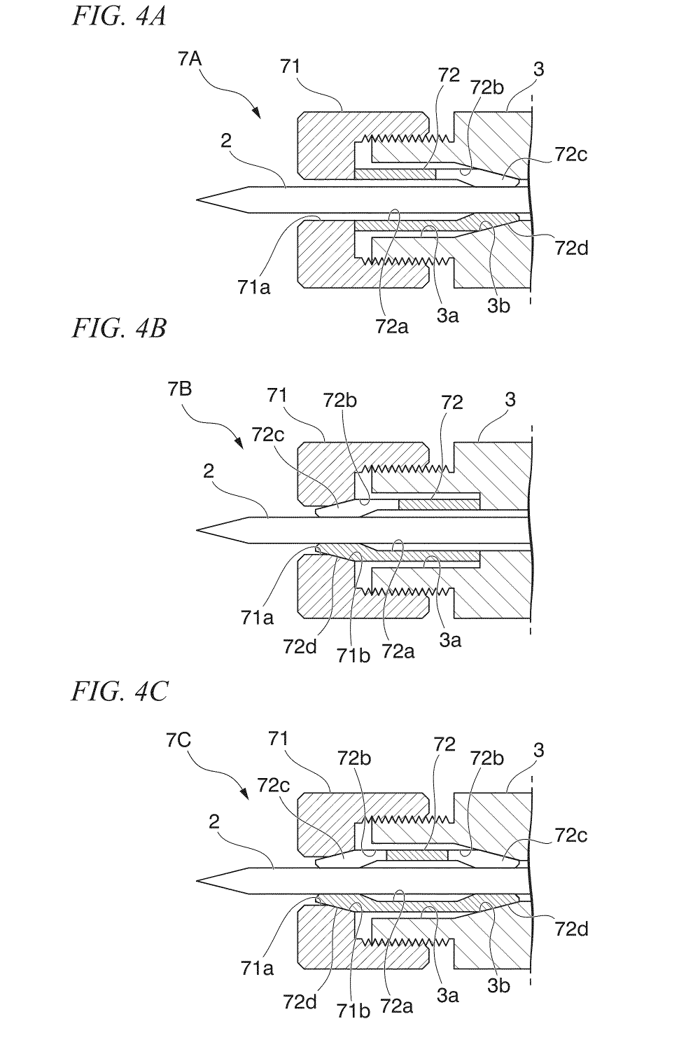

For example, although the above welding torch 1 has structure in which the non-consumable electrode 2 is mounted on the contact tip 3 via the fixing jig 7, a mounting structure using the fixing jig 7 shown in the FIG. 1B is not limited and, for example, a mounting structures using the fixing jigs 7A to 7C as shown in FIG. 4A to FIG. 4C are possible. In the fixing jigs 7A to 7C shown in FIG. 4A to FIG. 4C, common parts for each other are explained as a group and are given same signs.

In particular, the fixing jigs 7A to 7C shown in FIG. 4A to FIG. 4C have the cap member 71 and chock member 72 formed using the same material as the above fixing jig 7.

The cap member 71 comprises a roughly cylindrical member mounted on the tip end of the contact tip 3. Also, the cap member 71 has a trough-hole 71a passing through in the axis direction. Then, the cap member 71 can be threadably mounted on the outer circumference side of the contact tip 3 removably, in a state where the tip end of the contact tip 3 is inserted on the inside.

On the other hand, the chock member 72 comprises a roughly cylindrical member which can insert on the inside of the contact tip 3. Also, the chock member 72 has a trough-hole 72a passing through in the axis direction and supports the non-consumable electrode 2 which is inserted on the inside of the through-hole 72a as it can slide in the axis direction.

Moreover, among the fixing jigs 7A to 7C shown in FIG. 4A to FIG. 4C, the fixing jig 7A shown in FIG. 4A has a structure in which multiple slits 72b are provided side by side in a circumferential direction at the base end of the chock member 72. On the other hand, the fixing jig 7B shown in FIG. 4B has a structure in which multiple slits 72b are provided side by side in a circumferential direction at the tip side of the chock member 72. On the other hand, the fixing jig 7C shown in FIG. 4C has a structure in which multiple slits 72b are provided side by side in a circumferential direction at the tip side and end side of the chock member 72.

These multiple slits 72b are linearly-cutout midway in the axis direction from the base end or the tip side of the chock member 72. For this, a chock section 72c in which an elastic deformation can be changed in the shrunk radial direction are formed between each of slits 72b. Also, in the tip side of the chock section 72c, a taper section 72d, the radius of which is shrunk by little and little, is provided.

Then, in a mounting structure using fixing jigs 7A to 7C shown in FIG. 4A to FIG. 4C, the cap member 71 is mounted on the contact tip 3 in a state where the chock member 72 is inserted on the inside of the contact tip 3. Then, the taper section 72d of the chock member 72 is directly contacted with a taper surface 3b or 71b provided on the inside of the contact tip 3 or the cap member 71 and thereby the elastic deformation in the chock section 72c of this chock member 72 is worked in the shrunk radial direction. For this, the non-consumable electrode 2 can be fixed to the contact tip 3 while the non-consumable electrode 2 is sandwiched between the chock sections 72c.

In the above embodiments, using the conversion adapter kit 50, in which the conversion contact tip 3 and the fixing jigs 7 and 7A to 7C are provided and constructed, a case when MIG (or MAG) welding torch 200 is converted to TIG welding torch is exemplified.

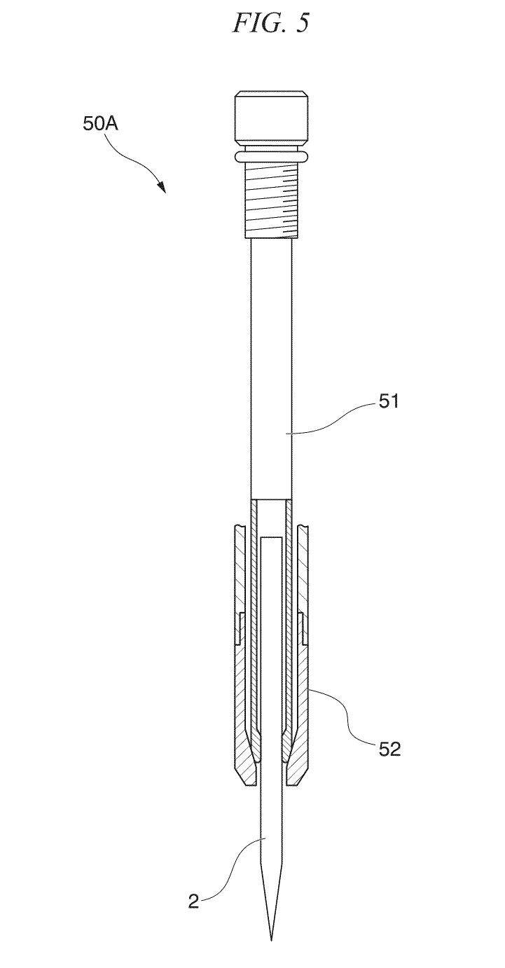

On the other hand, when MIG (or MAG) welding torch 200 shown in FIG. 14 is converted to the TIG welding torch, for example, a conversion adapter kit 50A as shown in FIG. 5, other than the above conversion adapter kit 50, can be used.

In particular, in the conversion adapter kit 50A, as shown in FIG. 5, a collet 51 which supports the non-consumable electrode 2 in a state where the non-consumable electrode 2 is inserted on the inside of the collet 51, a conversion collet body 52 on the inside of which the collet 51 is held in the state of projecting the non-consumable electrode 2 from the tip side and which instead of the contact tip 202 is mounted on the torch body 203 are provided.

Therefore, when the conversion adapter kit 50A is used, the torch body 203, torch nozzle 204, and handle 205 provided on MIG (or MAG) welding torch 200 shown in FIG. 14 can be applied.

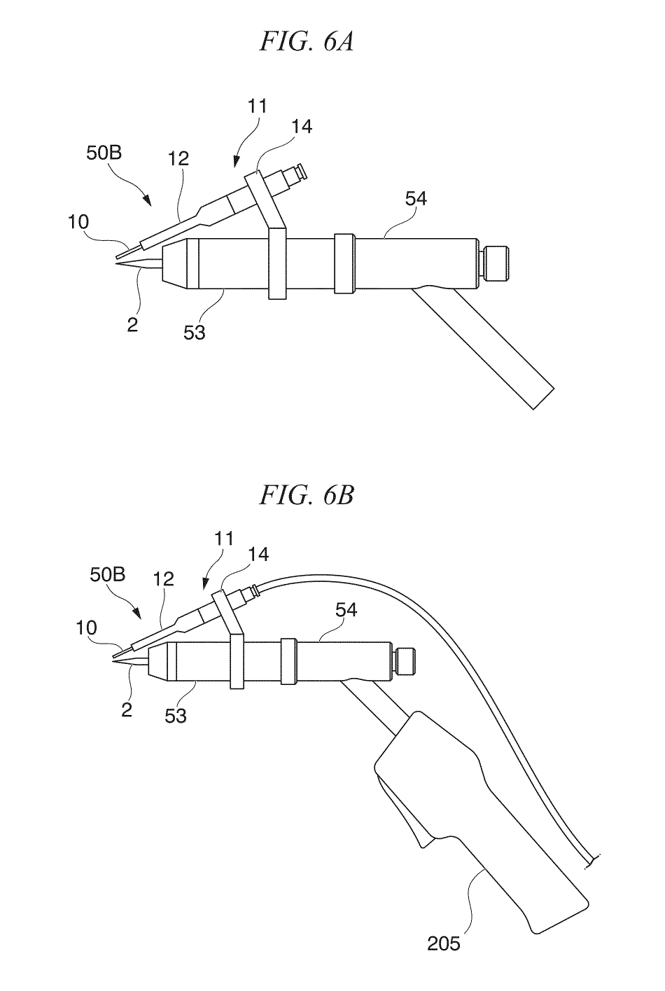

Moreover, when MIG (or MAG) welding torch 200 shown in FIG. 14 is converted to TIG welding torch, for example, the conversion adapter kit 50B shown in FIG. 6A and FIG. 6B can be used. FIG. 6A is a side view showing the conversion adapter kit 50B. FIG. 6B is a side view showing a state where the conversion adapter kit 50B is attached on the handle 205.

In particular, in the conversion adapter kit 50, as shown in FIG. 6A and FIG. 6B, a collet (not shown in figures) which supports the non-consumable electrode 2 in a state of inserting on the inside, a collet body (not shown in figures) on the inside of which the collet is held in a state of ejecting the non-consumable electrode 2 from a tip side, a torch nozzle 53 which is mounted on the collet body and from which a shield gas is ejected, and a conversion torch body 54 on which the collet body is mounted and which instead of the above torch body 203 is mounted on the handle 205, are provided in outline.

That is, the conversion adapter kit 50 can be the same structure as conventionally known TIG welding torch except that it can be mounted on the handle 205 provided in MIG (or MAG) welding torch 200 shown in FIG. 14

Therefore, when the conversion adapter kit 50B is used, the handle 205 provided in MIG (or MAG) welding torch 200 shown in FIG. 14 can be applied.

As above, in the welding torch according to the present invention, by using the conversion adapter kit 50, 50A, and 50B, a non-consumable electrode type welding torch in which as least one part of a contact body, torch body, torch nozzle, and handle provided in the consumable electrode type welding torch is applied can be constructed. Also, when using the conversion adapter kit according to the present invention, by mounting a non-consumable electrode type instead of a consumable electrode provided in consumable electrode type welding torch, a consumable electrode type welding torch can be easily converted to a non-consumable electrode type welding torch.

Moreover, the guide for wire positioning 11 is not always limited to the structure in which the feeding head 12 is removably mounted on the outer circumference section of the torch nozzle 5 via the attaching jig 14.

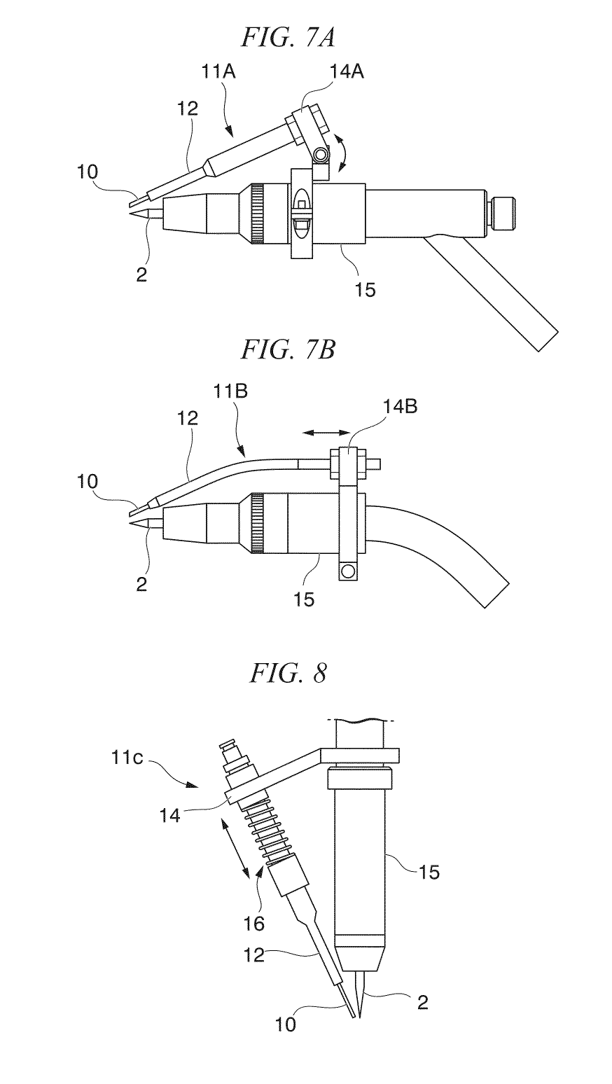

For example, as the guide for wire positioning 11A shown in FIG. 7A, a structure in which the feeding head 12 is removably mounted on the outer circumference section of the insulator (insulating tube) 15 mounted on the torch body 4 via the attaching jig 14A is possible.

The attaching jig 14A provided in the guide for wire positioning 11A rotatably supports the feeding head 12. For this, the slope angle θ of the welding wire 10 can be optionally adjusted.

On the other hand, as the guide for wire positioning 11B shown in FIG. 7B, a structure in which the attaching jig 14B slidably supporting the feeding head 12 in front-back direction is provided is possible. For this, a distance from the tip end of the welding wire 10 to the welding pool P can be optionally adjusted.

On the other hand, as the guide for wire positioning 11C shown in FIG. 8, a structure in which a damper feature 16 is disposed between the feeding head 12 and the attaching jig 14 is possible. The damper feature 16 slidably supports the feeding head 12 in front-back direction in a state where the feeding head 12 is biased toward by coil spring 16a. For this, when the tip end of the welding wire 10 is pushed to the object to be welded S during welding, a generation of swing or the like can be reduced with absorbing its impact. Because the entire length of the guide for wire positioning 11C in which the damper feature 16 is provided is long, the feeding head 12 is mounted on the outer circumference section of the torch body 4 via the attaching jig 14.

Also, the welding torch according to the present invention is not always limited to a single nozzle structure in which an inert gas (shield gas) such as argon and helium is ejected from the torch nozzle 5 and can be, for example, a double nozzle structure in which an inert gas is ejected as a shield gas from an inner torch nozzle (inner nozzle) and oxidation gas is ejected from an outer torch nozzle (outer nozzle) of the inner nozzle.

Moreover, although as the welding torch according to the present invention, any welding torch of air-cooling type and water-cooling type can be used, it is more preferable to use a water-cooling type welding torch. That is, in the air-cooling welding torch, a power feeding cable which supplies the electric power and a welding cable C in which a liner supplying a shield gas is provided are used and, in the water-cooling welding torch, a welding cable C in which a cooling cable for circulation of cooling water (cooling liquid) is further provided is used. Therefore, the water-cooling welding torch has more difficulty in suffering damage due to heat or impact and a welding operation to narrow part is possible by compacting the torch itself.

In addition, in the present invention, by mounting the feeding head 12 on MIG (or MAG) welding torch 200 shown in FIG. 14 via the attaching jig 14, a cold wire tandem welding can be also conducted. Also, the present invention can combine a hot wire and composite weld (tandem welding). A hot wire is a method of preliminary warming the welding wire 10 and because a welding speed is higher than one of the cold wire, welding with high weld deposit can be conducted. Moreover, when a consumable electrode type gas shield arc welding, in which the welding wire 10 is a consumable electrode, is conducted, welding with further higher weld deposit than hot wire can be conducted.

An object to be welded which the present invention targets is not especially limited and welding can be conducted for all material which can be welded.

### (Semi-automatic Welding System)

Next, one example of semi-automatic welding system according to the present invention will be explained.

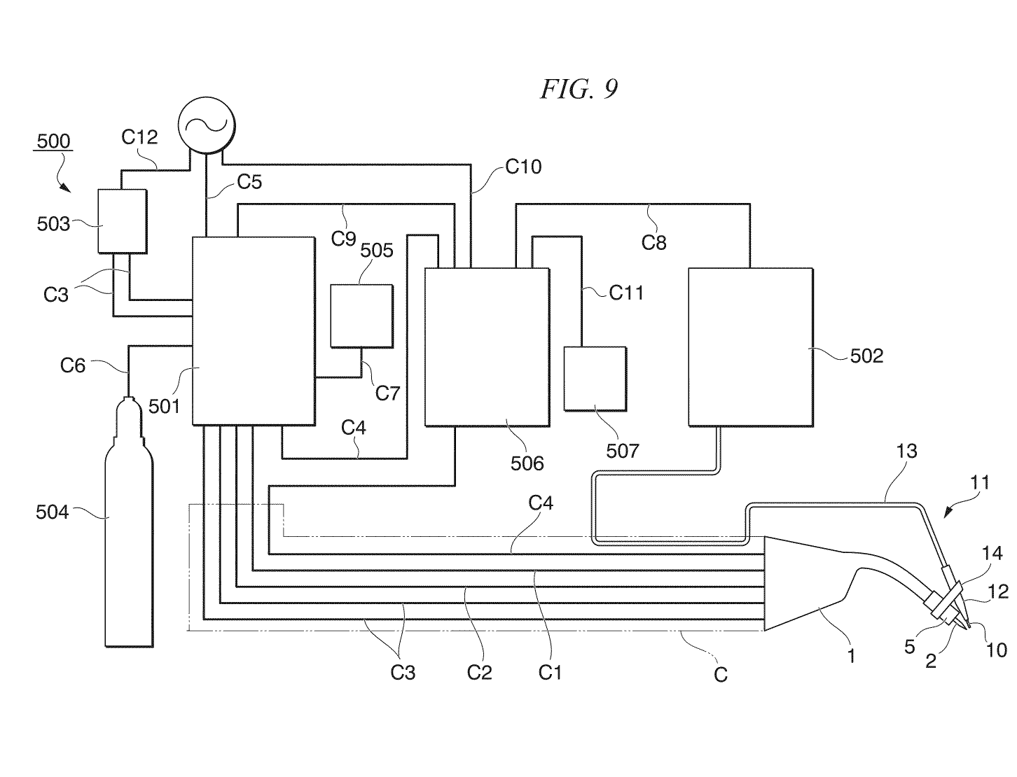

FIG. 9 is a schematic view showing one structure example of a semi-automatic welding system 500 according to the present invention.

In the semi-automatic welding system 500, as shown in FIG. 9, the welding torch 1, a welding power source 501 in which electric power and shield gas are supplied to the welding torch 1, a were feeder 502 in which the welding wire 10 is delivered to the guide for wire feeder 11, and a cooling apparatus 503 cooling the welding torch 1 are provided in the outline.

The welding torch 1 is connected to a welding power source 501 via the welding cable C. On the inside of the welding cable C, a power feeding cable C1 supplying electric power to the welding torch 1, a liner C2 introducing the shield gas, the cooling cable C3 in which the cooling water is cycled, and switch cable C4 electrically connected to a switch 6a of the welding torch 1 are provided.

The welding power source 501 has an electric source cable C5, at the tip end of which an outlet plug is provided and by connecting the outlet plug to an external electric source (for example, commercial electric source of alternating current 200V), electric power is supplied from the external electric source via the electric source C5. Also, a gas canister 504 is connected to the welding power source 501 via a gas cable C6 and a shield gas is supplied from the gas canister 504 via the gas cable C6. Moreover, a cooling cable C3 is connected to the welding power source 501.

Switch or the like for conducting various operations is provided in the welding power source 501. Also, a remote control 505 for remotely conducting various operations is electrically connected to the welding power source 501 via a connection cable C7.

Examples of a wire feeder 502 includes one in which a welding wire 10 rolled in a spool (not shown in figures) is delivered to a feeding head 12 via the liner 13. The liner 13 can be provided separately from the welding cable C or integrated with the welding cable C by disposing mid-part of the liner 13 on the inside of the welding wire C.

A wire control device 506 is connected to the wire feeder 502 via a control cable C8. The wire control device 506 controls driving of the wire feeder 502 and in particular, operates the welding torch 1, starts or stops to deliver the welding wire 10 according to an output setting or the like from the welding power source 501 to the welding torch 1, or adjusts a delivering speed or the like of the welding wire 10.

For this, the wire control device 506 is electrically connected to the welding power source 501 via a synchronous cable C9. Also, the switch cable C4 is electrically connected to the welding power source 501 via the wire control device 506.

Moreover, the wire control device 506 has an electric source cable C10, at the tip end of which an outlet plug is provided and by connecting the outlet plug to an external electric source (for example, commercial electric source of alternating current 200V), electric power is supplied from the external electric source via the electric source C10.

Also, Switch or the like for conducting various operations is provided in the wire control device 506. Also, a remote control 507 for remotely conducting various operations is electrically connected to the wire control device 506 via a connection cable C11.

A cooling device 503 is connected to the welding power source 501 via the cooling cable C3. The cooling device 503 has a tank storing cooling water, a pump pressure-feeding the cooling water, a radiator cooling the cooling water, and the like and forcibly cycles the cooling water via the cooling cable C3.

Also, the cooling device 503 has an electric source cable C12, at the tip end of which an outlet plug is provided and by connecting the outlet plug to an external electric source (for example, commercial electric source of alternating current 200V), electric power is supplied from the external electric source via the electric source C12.

When welding, the semi-automatic welding system 500 having such above structure becomes on-state by user's pushing of a switch 6a of the welding torch 1. In this time, the electric power (alternating or direct) is supplied from the welding power source 501 to the welding torch 1 via the power feeding cable C1 and the shield gas is supplied to the welding torch 1 via the liner C2. Also, the welding wire 10 delivered by the wire feeder 502 is delivered from the tip end of the feeding head 12 via the liner 13.

For this, in a state where the shield gas is ejected from the torch nozzle 5 of the welding torch 1 and an arc is generated between the non-consumable electrode 2 and the object to be welded, welding is conducted with automatically delivered welding wire 10 melting in the arc. Also, during welding, the welding torch 1 is cooled with the cooling water being recycled.

As above, in the semi-automatic welding system 500, a semi-automatic TIG welding (non-consumable electrode type gas shield arc welding) using the welding torch 1 can be conducted.

The semi-automatic welding system 500 according to the present invention can conduct welding with a high speed and high weld deposit as well as preventing a generation of sputter by using the welding torch 1. Also, because a user needs not conduct both supply of filler metal and control of TIG welding torch 100 with right and left hands at the same time as a conventional manually-powered TIG welding, welding to obtain a good end result can be conducted without needing a skilled technique. In particular, by using the welding power source 501 having 200 A or more of the maximum in the rated output current, a semi-automatically TIG welding accepting high current can be conducted.

Moreover, even when flowing high current in semi-automatically TIG welding, because the welding torch 1 applies MIG (or MAG) welding torch 200 accepting high current, for example, there is possibility of preventing that the torch nozzle 5, the guide for wire positioning 11, and the like, are broken due to heat, as conventionally TIG welding torch.

In addition, when using mixed gas (MAG welding) in which oxygen or carbon dioxide is mixed with a shield gas, or 100% carbon dioxide (carbon dioxide arc welding), materials in which welding defects such as holes are generated can be also used.

Also, even when manually operating the welding torch 1, because the distance from the arc to the handle 6 is more sufficient than conventionally TIG welding torch, it is possible to prevent hands from being burn.

Moreover, even when the guide for wire positioning 11 is mounted on the welding torch 1 and semi-automatically TIG welding is conducted, because the distance from the torch nozzle 5, on which the guide for wire positioning 11 is mounted, to the handle 6 is sufficient, the guide for wire positioning 11 is not a hamper during welding.

The semi-automatic welding system 500 according to the present invention uses not only the welding torch 1 but also the welding power source, the wire feeder (including the wire control device), and cooling device for MIG (or MAG) welding as well as the welding power source, the wire feeder (including the wire control device), and cooling device for TIG welding, regarding the welding power source 501, the wire feeder 502(including the wire control device 506), and cooling device 503.

That is, in the non-consumable electrode type semi-automatic welding system according to the present invention, by applying at least one part of a consumable electrode type semi-automatic welding system, semi-automatically TIG welding can be conducted with high speed and high weld deposit like MIG (or MAG) welding.

In addition, it is not necessary that an additional TIG welding system accepting high current is prepared and a non-consumable electrode type semi-automatic welding system accepting such a high current can be provided at a low price by applying a MIG (or MAG) welding system along with the welding torch 1.

### EXAMPLES

Hereinafter, the effects of the invention will be further clarified using examples. The present invention is not limited to the examples below and can be appropriately modified within the scope of the invention for practical use.

### Example 1

In Example 1, a butt welding was actually conducted using the welding torch 1 shown in FIG. 1A and FIG. 1B. The welding conditions are as follows. Material of object to be welded: SUS304 (austenite stainless steel), sheet thickness of 12 mm

Shield gas: mixed gas of 93% Ar gas and 7% H₂ gas (Condition 1), 100% Ar gas (Condition 2)

Non-consumable electrode: tungsten electrode bar, diameter of 3.2 mm

Electric current: peak current of 350 A, base current of 200 A, pulse frequency of 30 Hz

Welding wire: SUS308L, diameter of 1.6 mm, delivering speed of 3.5M/min

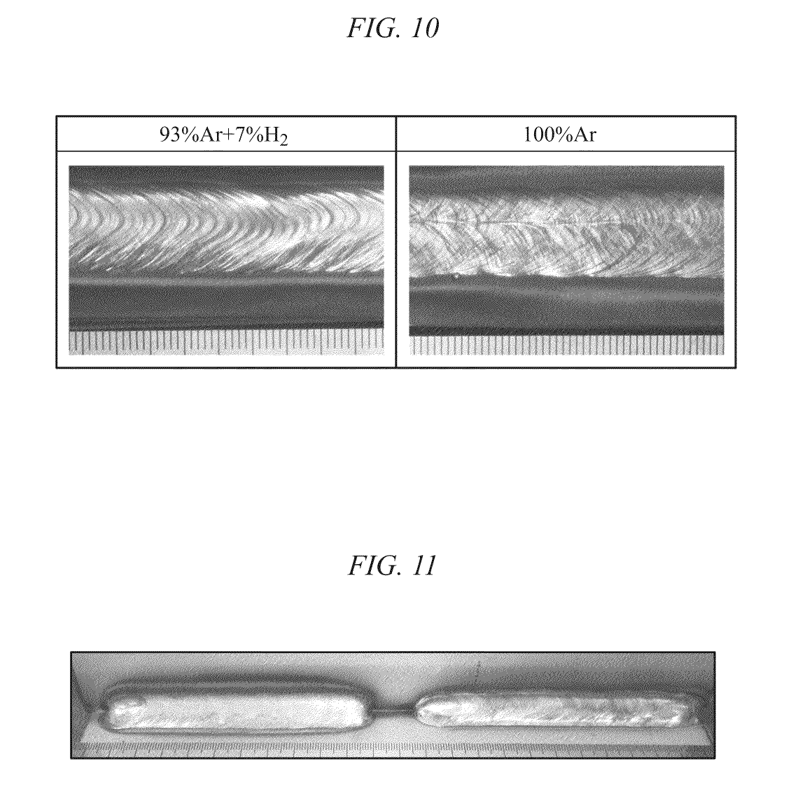

Then, photographs after welding are shown in FIG. 10. A photograph of left side in FIG. 10 is the case of Condition 1 and a photograph of right side in FIG. 10 is the case of Condition 2.

As shown in FIG. 10, the welded part was a beautiful end result with no welding defect.

### Example 2

In Example 2, a horizontal fillet welding was actually conducted using the welding torch 1 shown in FIG. 1A and FIG. 1B. The welding conditions are as follows. Material of object to be welded: UNS S32750 (two-phase stainless steel), sheet thickness of 8 mm

Shield gas: mixed gas of 50% Ar gas and 50% He gas (Condition 1), mixed gas of 93% Ar gas and 7% H₂ gas (Condition 2)

Non-consumable electrode: tungsten electrode bar, diameter of 4.0 mm

Electric current: peak current of 320 A, base current of 300 A, pulse frequency of 30 Hz

Welding wire: 329J4L, diameter of 1.2 mm, delivering speed of 6M/min

Then, photographs after welding are shown in FIG. 11. A photograph of left side in FIG. 11 is the case of Condition 1 and a photograph of right side in FIG. 11 is the case of Condition 2.

As shown in FIG. 11, the welded part was a beautiful end result with no welding defect.

### Example 3

In Example 3, horizontal fillet welding was actually conducted using the semi-automatic welding torch 1 shown in FIG. 1A and FIG. 1B and the manually-powered TIG welding torch 100 shown in FIG. 13A and FIG. 13B and the comparison was conducted.

Welding conditions regarding the semi-automatic welding torch 1 shown in FIG. 1A and FIG. 1B are as follows.

Material of object to be welded: SUS304 (austenite stainless steel), sheet thickness of 10 mm

Shield gas: mixed gas of 50% Ar gas and 50% H₂ gas

Non-consumable electrode: tungsten electrode bar, diameter of 3.2 mm

Electric current: 300 A

Welding wire: SUS308L, diameter of 0.9 mm, delivering speed of 7.0M/min

On the other hand, welding conditions regarding the TIG welding torch 100 shown in FIG. 13A and FIG. 13B are as follows.

Material of object to be welded: SUS304 (austenite stainless steel), sheet thickness of 10 mm

Shield gas: mixed gas of 50% Ar gas and 50% H₂ gas

Non-consumable electrode: tungsten electrode bar, diameter of 3.2 mm

Electric current: 300 A

Welding wire: SUS308L, diameter of 2.4 mm, delivering by hand

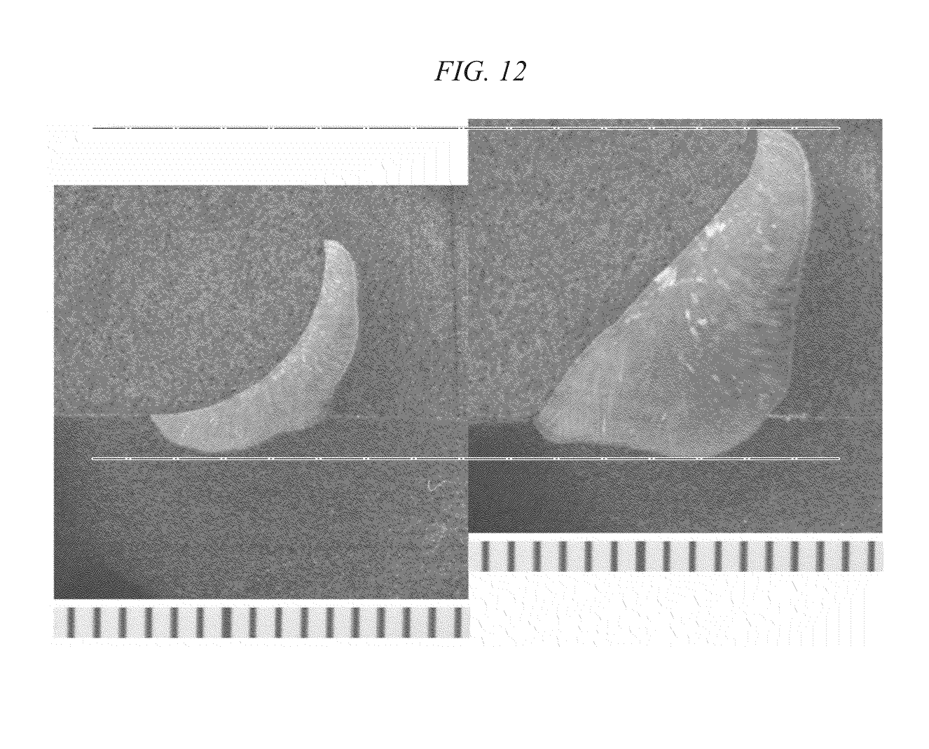

Then, photographs after welding are shown in FIG. 12. A photograph of right side in FIG. 12 is the case using the semi-automatic welding torch 1 shown in FIG. 1A and FIG. 1B and a photograph of left side in FIG. 12 is the case using the manually-powered TIG welding torch 100 shown in FIG. 13A and FIG. 13B.

As shown in FIG. 12, the case of using the semi-automatic welding torch 1 shown in FIG. 1A and FIG. 1B could conduct welding at short time in which a weld deposit rate is higher and a depth of penetration is deeper than the case of using the manually-powered TIG welding torch 100 shown in FIG. 13A and FIG. 13B.

As above, according to the present invention, a welding with a high speed and a high weld deposit can be conducted with preventing sputter from being generated.

### REFERENCE SIGNS LIST

1 welding torch
2 non-consumable electrode
3 contact tip
4 torch body
5 torch nozzle
6 handle
7, 7A-7D fixing jig
8 tip body
9 orifice
10 welding wire
11, 11A-11C guide for wire positioning
12 feeding head
13 liner
14, 14A, 14B attaching jig insulator
16 damper feature
50, 50A, 50B conversion adapter kit
51 collet
52 collet body
53 torch nozzle
54 torch body
71 cap member
72 chock member
500 semi-automatic welding system
501 welding power source
502 wire feeder device
503 cooling device
504 gas canister
505 remote control
506 wire control device
507 remote control
C welding cable
S object to be welded
P welding pool

1. A non-consumable electrode type semi-automatic welding system, comprising:
a welding torch in which a non-consumable electrode generating an arc between an object to be welded and the non-consumable electrode and a torch nozzle ejecting a shield gas toward a welding pool of the object to be welded generated by the arc are provided;
a wire feeder which delivers a welding wire toward the welding pool of the object to be welded from a tip end of a feeding head mounted on the welding torch via an attaching jig; and
a welding power source which supplies electric power and the shield gas to the welding torch; wherein
one or more among the welding torch, the wire feeder, and the welding power source applies at least one part among a welding torch, a wire feeder, and a welding power source provided in a consumable electrode type semi-automatic welding system.

2. A non-consumable electrode type semi-automatic welding system according to claim 1, wherein
the welding torch applies at least one of parts of a consumable electrode type welding torch in which a contact tip delivers a consumable electrode from a tip end; a torch body on which the contact tip is mounted; a torch nozzle which is mounted on the torch body and ejects a shield gas; and a handle on which the torch body is mounted and which a user grips are provided.

3. A non-consumable electrode type semi-automatic welding system according to claim 2, wherein the welding torch applies at least the torch body, torch nozzle, and handle provided in the consumable electrode type welding torch by providing a conversion contact tip which instead of the contact tip is mounted on the torch body and a fixing jig with which the non-consumable electrode is mounted on the conversion contact tip.

4. A non-consumable electrode type semi-automatic welding system according to claim 2, wherein the welding torch applies at least the torch body, torch nozzle, and handle provided in the consumable electrode type welding torch by providing a collet which supports the non-consumable electrode in a state of inserting the non-consumable electrode inside and a conversion collet body which holds the collet inside in a state of ejecting the non-consumable electrode from a tip side and which instead of the contact tip is mounted on the torch body.

5. A non-consumable electrode type semi-automatic welding system according to claim 2, wherein the welding torch applies at least the handle provided in the consumable electrode type welding torch by providing a collet which supports the non-consumable electrode in a state of inserting the non-consumable electrode on the inside; a collet body which holds the collet inside in a state of ejecting the non-consumable electrode from a tip side; the torch nozzle which is mounted on the collet body and ejects the shield gas; and a conversion torch body on which the collet body is mounted and which, instead of the torch body, is mounted on the handle.

6. A non-consumable electrode type semi-automatic welding system according to claim 1, wherein the feeding head applies a contact tip provided in the consumable electrode type welding torch.

7. A non-consumable electrode type semi-automatic welding system according to claim 1, wherein, in the feeding head, a delivering position of the welding wire can be adjusted by changing a position of the attaching jig.

8. A non-consumable electrode type semi-automatic welding system according to claim 1, wherein the welding power source applies at least one part of the electric source device provided in the consumable electrode type semi-automatic welding system.

9. A non-consumable electrode type semi-automatic welding system according to claim 8, wherein the maximum of a rated output current in the welding power source is 200 A or more.

10. A non-consumable electrode type semi-automatic welding system according to claim 1, wherein the wire feeder applies at least one part of a wire feeder provided in the consumable electrode type or the non-consumable electrode type semi-automatic welding system.

11. A non-consumable electrode type semi-automatic welding system according to claim 1, wherein a cooling device which cools the welding torch by connecting to the welding power source and recycling cooling liquid flowing in the welding torch is provided.

12. A conversion adapter kit, with which a consumable electrode type welding torch including:
a contact tip which delivers a consumable electrode from a tip end;
a torch body on which the contact tip is mounted
a torch nozzle which is mounted on the torch body and ejects a shield gas
a handle on which the torch body is mounted and which a user grips, is converted to a non-consumable electrode type welding torch including
a non-electrode which generates an arc between the non-consumable electrode and object to be welded, comprising:
a conversion contact tip which instead of the contact tip is mounted on the torch body; and
a fixing jig with which the non-consumable electrode is mounted on the conversion contact tip.

13. A conversion adapter kit, with which a consumable electrode type welding torch including:
a contact tip which delivers a consumable electrode from a tip end;
a torch body on which the contact tip is mounted
a torch nozzle which is mounted on the torch body and ejects a shield gas
a handle on which the torch body is mounted and which a user grips, is converted to a non-consumable electrode type welding torch including
a non-electrode which generates an arc between the non-consumable electrode and object to be welded, comprising:
a collet which supports the non-consumable electrode in a state of inserting the non-consumable electrode on the inside; and
a conversion collet body which holds the collet inside in a state of ejecting the non-consumable electrode from a tip side and which is instead of the contact tip mounted on the torch body.

14. A conversion adapter kit, with which a consumable electrode type welding torch including:
a contact tip which delivers a consumable electrode from a tip end;
a torch body on which the contact tip is mounted
a torch nozzle which is mounted on the torch body and ejects a shield gas
a handle on which the torch body is mounted and which a user grips, is converted to a non-consumable electrode type welding torch including
a non-electrode which generates an arc between the non-consumable electrode and object to be welded, comprising:
a collet which supports the non-consumable electrode in a state of inserting the non-consumable electrode on the inside;
a collet body which holds the collet inside in a state of ejecting the non-consumable electrode from a tip side; and
a conversion torch body on which the collet body is mounted and which instead of the torch body is mounted on the handle.

15. A conversion adapter kit according to claim 12, further comprising: a non-consumable electrode.

16. A conversion adapter kit according to claim 12, further comprising:
a feeding head which delivers a welding wire from a tip end; and
an attaching jig with which the feeding head is mounted on the welding torch.

17. A conversion adapter kit according to claim 16, wherein the feeding head applies the contact tip provided in the consumable electrode type welding torch.

18. A conversion adapter kit according to claim 16, wherein, in the feeding head, a delivering position of the welding wire can be adjusted by changing a position of the attaching jig.

19. A welding torch on which a conversion adapter kit according to claim 1 is mounted.
